(19) United States
(12) Patent Application Publication
(10) Pub. No.: US 2015/0271466 A1
(43) Pub. Date: Sep. 24, 2015

(54) MEASURING DEVICE, MEASURING METHOD, AND COMPUTER PROGRAM PRODUCT

(71) Applicant: KABUSHIKI KAISHA TOSHIBA, Tokyo (JP)

(72) Inventor: Masaki Yamazaki, Tokyo (JP)

(21) Appl. No.: 14/645,572

(22) Filed: Mar. 12, 2015

(30) Foreign Application Priority Data
Mar. 20, 2014 (JP) 2014-058703

(51) Int. Cl. H04N 13/02; G06K 9/46; G06T 7/00; G01B 11/25

(52) U.S. Cl. CPC H04N 13/0203; G01B 11/254; G06K 9/468; G06K 9/4661; G06T 7/0042

(57) ABSTRACT

According to an embodiment, a measuring device includes a projector, an image capturing unit, a first calculator, a setting unit, and a second calculator. The projector projects, onto an object, a first pattern in which predetermined designs are distributed randomly and a second pattern in which a luminance value changes according to a sinusoidal wave function having a frequency. The image capturing unit captures a first image of the object onto which the first pattern is projected and a second image of the object onto which the second pattern is projected. The first calculator calculates a distance to the object by using the first pattern and the first image. The setting unit sets the frequency of a sinusoidal wave function by using the distance. The second calculator calculates a three-dimensional shape of the object by using the second pattern and the second image.

### CROSS-REFERENCE TO RELATED APPLICATIONS

This application is based upon and claims the benefit of priority from Japanese Patent Application No. 2014-058703, filed on Mar. 20, 2014; the entire contents of which are incorporated herein by reference.

### FIELD

Embodiments described herein relate generally to a measuring device, a measuring method, and a computer program product.

### BACKGROUND

As measuring method of the three-dimensional shape of a non-textured object such as a metal object, pattern projection methods are known in which the three-dimensional shape of an object is measured by projecting a pattern, which has a regular design, onto the object; taking an image of the object onto which the pattern is projected; and obtaining the correspondence relationship between the pattern and the image.

Among such pattern projection methods, a pattern shift method is known that uses a pattern in which the luminance value changes according to a sinusoidal wave function. As a result of implementing the pattern shift method, the three-dimensional shape of an object can be measured with sub-pixel accuracy. Hence, a high degree of measurement accuracy is achieved.

However, in the phase shift method, in order to prevent a decline in the measurement accuracy, the pattern projected onto the object needs to be captured at an appropriate resolution. For that reason, in the phase shift method, the frequency of the sinusoidal wave function needs to be set in such a way that a periodically-repeating design (a striped design) in the pattern has the width suitable for the distance to the object.

For example, in JP-A 2011-127932 (KOKAI), a technology is disclosed in which a phase pattern is projected onto a target object for measurement as well as onto a backside screen disposed on the backside of the target object for measurement; and the reflected patterns from the target object for measurement and the backside screen are analyzed so as to generate a phase pattern that is adjusted to have a grating width for each period suitable for the distance to the target object for measurement. Then, the generated phase pattern is projected onto the target object for measurement, and the reflected pattern from the target object for measurement is analyzed so as to measure the three-dimensional shape of the target object for measurement.

However, in the conventional technology mentioned above, unless a reference object such as a backside screen is disposed around the concerned object; the sinusoidal wave function that is used in generating a pattern cannot be set to have the frequency suitable for the distance to the object. Hence, it is not possible to measure the three-dimensional shape of the object with a high degree of accuracy.

### BRIEF DESCRIPTION OF THE DRAWINGS

FIG. 1 is a block diagram illustrating an exemplary configuration of a measuring device according to a first embodiment;

FIG. 2 is a diagram illustrating an exemplary first pattern according to the first embodiment;

FIG. 3 is a diagram illustrating an exemplary first pattern according to the first embodiment;

FIG. 4 is a diagram illustrating an exemplary second pattern according to the first embodiment;

FIG. 5 is a diagram illustrating an exemplary second pattern according to the first embodiment;

FIG. 6 is a diagram illustrating exemplary second patterns projected onto objects according to the first embodiment;

FIG. 7 is a flowchart for explaining an exemplary sequence of operations performed according to the first embodiment;

FIG. 8 is a block diagram illustrating an exemplary configuration of a measuring device according to a second embodiment;

FIG. 9 is a diagram illustrating exemplary second patterns projected onto objects according to the second embodiment;

FIG. 10 is a flowchart for explaining an exemplary sequence of operations performed according to the second embodiment; and

FIG. 11 is a block diagram illustrating an exemplary hardware configuration of the measuring device according to the embodiments mentioned above.

### DETAILED DESCRIPTION

According to an embodiment, a measuring device includes a projector, an image capturing unit, a first calculator, a setting unit, and a second calculator. The projector projects, onto an object, a first pattern in which predetermined designs are distributed randomly and a second pattern in which a luminance value changes according to a sinusoidal wave function having a frequency. The image capturing unit captures a first image of the object onto which the first pattern is projected and a second image of the object onto which the second pattern is projected. The first calculator calculates a distance to the object by using the first pattern and the first image. The setting unit sets the frequency of a sinusoidal wave function by using the distance. The second calculator calculates a three-dimensional shape of the object by using the second pattern and the second image.

Embodiments will be described below in detail with reference to the accompanying drawings.

### First Embodiment

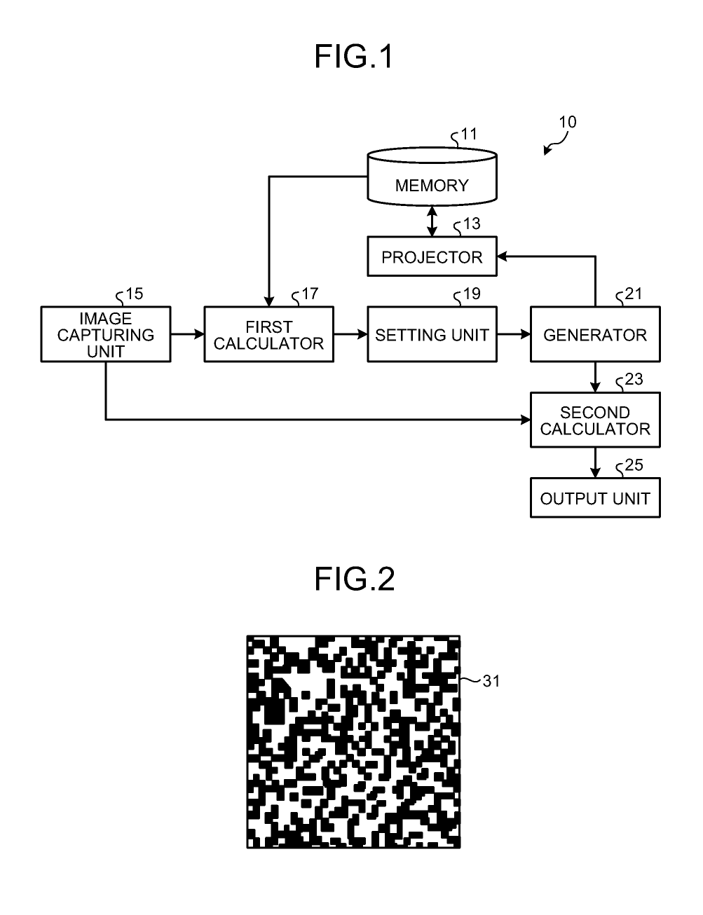

FIG. 1 is a block diagram illustrating an exemplary configuration of a measuring device 10 according to a first embodiment. The measuring device 10 includes a memory 11, a projector 13, an image capturing unit 15, a first calculator 17, a setting unit 19, a generator 21, a second calculator 23, and an output unit 25.

The memory 11 is implemented using a memory device such as a hard disk drive (HDD), a solid state drive (SSD), a memory card, an optical disk, a read only memory (ROM), or a random access memory (RAM) in which information can be stored in a magnetic, optical, or electrical manner. The projector 13 can be implemented using a projecting device such as a projector, a laser, or a lamp that is capable of projecting light of arbitrary patterns from a light source. The image capturing unit 15 can be implemented using an imaging device such as a digital camera or a stereo camera. Meanwhile, the first calculator 17, the setting unit 19, the generator 21, the second calculator 23, and the output unit 25 can be implemented by executing computer programs in a processor such as a central processing unit (CPU), that is, can be implemented using software; or can be implemented using hardware such as an integrated circuit (IC); or can be implemented using a combination of software and hardware.

The memory 11 is used to store various computer programs executed in the measuring device 10 and to store data used in various operations that are performed in the measuring device 10. Moreover, the memory 11 is used to store a first pattern in which a predetermined design is arranged in a random manner.

FIG. 2 is a diagram illustrating an example of a first pattern 31 according to the first embodiment. The first pattern 31 is a random dot pattern in which dots having the luminance values expressed in binary (white or black) are arranged in a random manner.

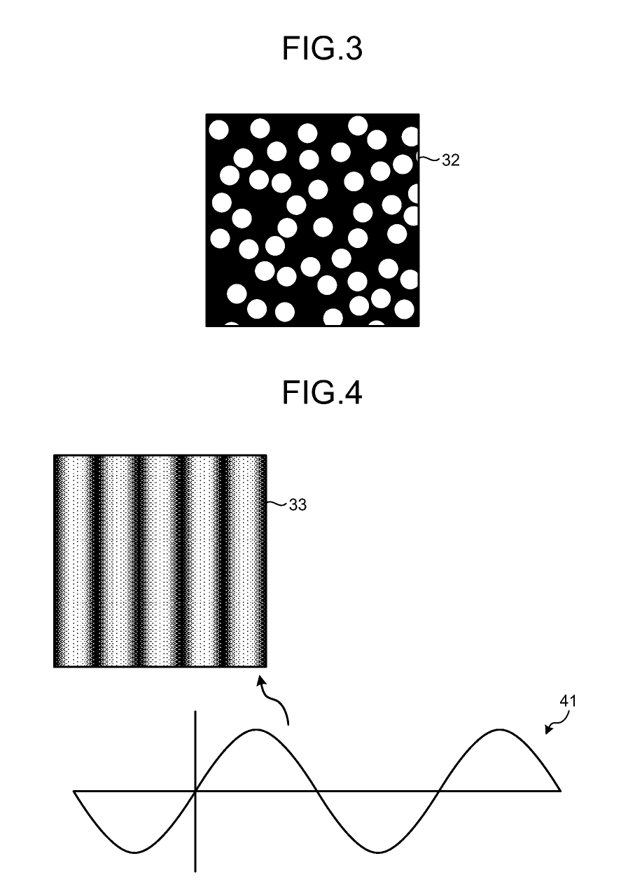

FIG. 3 is a diagram illustrating an example of a first pattern 32 according to the first embodiment. The first pattern 32 is a geometrical pattern in which circles having the luminance values expressed in binary (white or black) are arranged in a random manner. Herein, the elements constituting the geometrical pattern are not limited to circles, but can also be rectangles or lines.

The projector 13 projects the first pattern, which is stored in the memory 11, onto an object. More particularly, the projector 13 projects the first pattern onto the object by projecting, onto the object, the light transmitted through the first pattern or the reflected light from the first pattern. Meanwhile, the light projected by the projector 13 can be visible light or can be non-visible light such as infrared light.

The image capturing unit 15 captures a first image, which is the image of the object onto which the projector 13 has projected the first pattern. If the light projected by the projector 13 is visible light, then the image capturing unit 15 can be configured to be able to receive visible light. Similarly, if the light projected by the projector 13 is non-visible light, then the image capturing unit 15 can be configured to be able to receive non-visible light. In the first embodiment, it is assumed that the image capturing unit 15 captures a first image from a single direction. However, alternatively, the image capturing unit 15 can capture a first image from a plurality of directions.

Meanwhile, it is assumed that the calibration for calculating the focal length of the projector 13 is done in advance; the calibration for calculating the focal length of the image capturing unit 15 is done in advance; and the calibration for calculating the positional relationship between the projector 13 and the image capturing unit 15 is done in advance.

The first calculator 17 calculates the distance to the object by using the first pattern, which is stored in the memory 11, and the first image, which is captured by the image capturing unit 15. More particularly, for each image unit pixel that represents the unit pixel in the first image, the first calculator 17 calculates, as the distance, a three-dimensional distance to the position in the object that corresponds to the image unit pixel. In the first embodiment, the explanation is given for a case in which the unit pixel (the image unit pixel) represents a single pixel. However, that is not the only possible case.

In the first embodiment, the first calculator 17 detects the first pattern in the first image, and obtains the corresponding position between the detected first pattern and the first pattern stored in the memory 11. For example, the first calculator 17 divides the detected first pattern into a plurality of blocks; divides the first pattern stored in the memory 11 into a plurality of blocks; performs inter-block matching; and uniquely obtains the corresponding position between the detected first pattern and the first pattern stored in the memory 11. Herein, the evaluation of inter-block matching can be performed using, for example, the sum of absolute difference (SAD) of the pixel values. Since the first pattern has a predetermined design arranged in a random manner, inter-block matching enables obtaining the corresponding position in a unique manner.

Then, based on the corresponding position thus obtained, the first calculator 17 obtains the three-dimensional distance from the measuring device 10 to the object. For example, the first calculator 17 implements an existing three-dimensional distance measuring method, such as triangulation, with respect to the corresponding position thus obtained; and calculates, for each image unit pixel of the first image, the three-dimensional distance (the three-dimensional distance in the depth direction) from the measuring device 10 to the position in the object that corresponds to the image unit pixel (i.e., to the position of the image of the object appearing at the image unit pixel).

The setting unit 19 sets the frequency of the sinusoidal wave function by using the distance calculated by the first calculator 17. Herein, the setting unit 19 sets the frequency of the sinusoidal wave function for each projection unit pixel, which is the unit pixel of the projector 13. In the first embodiment, the explanation is given for a case in which the unit pixel (the projection unit pixel) represents a single pixel. However, that is not the only possible case.

More particularly, for each image unit pixel of the first image, the setting unit 19 uses the three-dimensional distance of that image unit pixel and calculates the number of projection unit pixels corresponding to the image unit pixel. Moreover, for each projection unit pixel of the projector 13, the setting unit 19 sets the frequency at the projection unit pixel based on the number of pixels calculated at the corresponding image unit pixel.

For example, for each projection unit pixel, the setting unit 19 performs setting in such a way that the number of pixels required for the unit period of the sinusoidal wave function at the projection unit pixel is equal to or smaller than half of the number of pixels calculated at the image unit pixel corresponding to the projection unit pixel; and then sets the frequency at the projection unit pixel according to the number of pixels thus set. More specifically, as the number of pixels required for the unit period of the sinusoidal wave function at each projection unit pixel, the setting unit 19 sets, in descending order, natural numbers equal to or smaller than half of the number of pixels calculated at the image unit pixel corresponding to the projection unit pixel; and calculates phase errors of the sinusoidal wave function. Then, the setting unit 19 sets the natural number having the phase error equal to or greater than a threshold value as the number of pixels required for the unit period. In the first embodiment, the explanation is given for a case in which the unit period represents a single period. However, that is not the only possible case.

Given below is the concrete explanation about the method of setting the frequency of the sinusoidal wave function for each projection unit pixel of the projector 13.

Firstly, assume that f_{c} represents the focal length of the image capturing unit 15; d_{c} represents the pixel pitch of the image capturing unit 15; and l_{c}(x, y) represents the distance from the measuring device 10 (the image capturing unit 15) to the position of the object corresponding to the position of the image of the object appearing at an pixel of interest (x, y) in the first image. In that case, a single pixel of the image capturing unit 15 is formed at a size n_{c}(x, y) calculated using Equation (1) given below.

Herein, the distance l_{c}(x, y) is obtained from the three-dimensional distance calculated by the first calculator 17. Moreover, the focal length f_{c} and the pixel pitch d_{c} are obtained from the abovementioned calibration performed in advance.

$${n}_{c} ( x , y ) = \frac{{1}_{c} ( x , y ) \cdot {d}_{c}}{{f}_{c}} \qquad ( 1 )$$

In an identical manner, assume that fₚ represents the focal length of the projector 13; dₚ represents the pixel pitch of the projector 13; and lₚ(x′, y′) represents the distance from the measuring device 10 (the image capturing unit 15) to a pixel of interest (x′, y′) in the first pattern projected by the projector 13. In that case, a single pixel of the projector 13 is formed at a size nₚ(x′, y′) calculated using Equation (2) given below.

Herein, the distance lₚ(x′, y′) is obtained from the three-dimensional distance calculated by the first calculator 17. Moreover, the focal length fₚ and the pixel pitch dₚ are obtained from the abovementioned calibration performed in advance.

$${n}_{p} ( {x}^{′} , {y}^{′} ) = \frac{{1}_{c} ( {x}^{′} , {y}^{′} ) \cdot {d}_{p}}{{f}_{p}} \qquad ( 2 )$$

Accordingly, the number m(x, y) of pixels of the projector 13 that are projected onto each pixel of the image capturing unit 15 is calculated by the setting unit 19 using Equation (3) given below.

$$m ( x , y ) = \frac{{n}_{c} ( x , y )}{{n}_{p} ( {x}^{′} , {y}^{′} )} = \frac{{1}_{c} ( x , y ) \cdot {f}_{p} \cdot {d}_{c}}{{1}_{p} ( {x}^{′} , {y}^{′} ) \cdot {f}_{c} \cdot {d}_{p}} \qquad ( 3 )$$

Meanwhile, consider a case in which the distance from the lens center of the image capturing unit 15 to the object is identical to the distance from the lens center of the projector 13 to the object, that is, consider a case in which l_{c}(x, y)=lₚ(x′, y′) holds true. In that case, even if there is a change in the distance from the measuring device 10 to the object, the number m(x, y) of pixels of the projector 13 that are projected onto each pixel of the image capturing unit 15 remains constant. However, if l_{c}(x, y)≠lₚ(x′, y′) holds true, then the number m(x, y) of pixels of the projector 13 that are projected onto each pixel of the image capturing unit 15 is not constant.

Then, by using the calculated number m(x, y) of pixels, the setting unit 19 sets, for each projection unit pixel of the projector 13, the frequency of the sinusoidal wave function in such a way that a second pattern that is projected later on by the projector 13 is captured at a suitable resolution of the image capturing unit 15. Herein, the second pattern is a pattern in which the luminance value changes according to the sinusoidal wave function.

FIG. 4 is a diagram illustrating an example of a second pattern 33 according to the first embodiment. The second pattern 33 is a pattern in which the luminance value changes in binary according to a sinusoidal wave function 41.

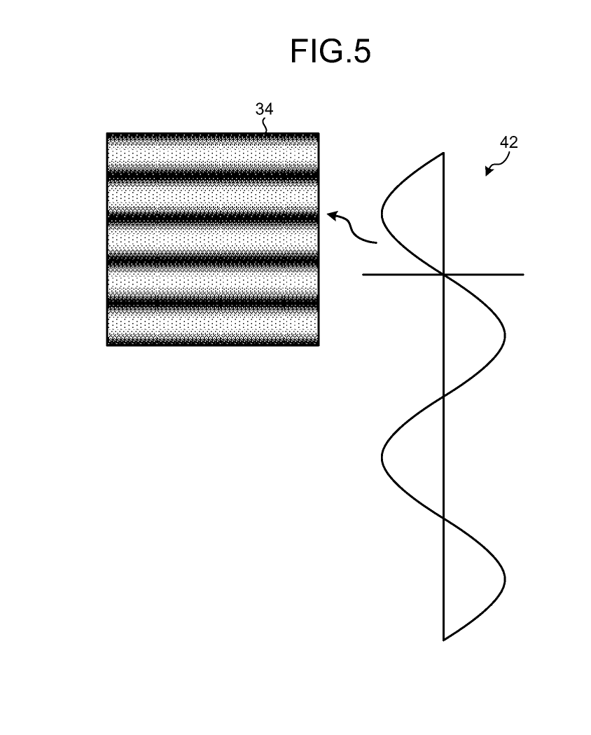

FIG. 5 is a diagram illustrating an example of a second pattern 34 according to the first embodiment. The second pattern 34 is a pattern in which the luminance value changes in binary according a sinusoidal wave function 42.

Herein, setting the frequency of the sinusoidal wave function to the greatest value possible, that is, shortening the wavelength of the sinusoidal wave function contributes in achieving enhancement in the eventual measurement accuracy.

However, in order to restore information about the second pattern, which is projected by the projector 13, from a second image that is formed by the image capturing unit 15 by capturing the second pattern projected by the projector 13; it is necessary to satisfy the Nyquist criterion. Herein, the Nyquist criterion is a sampling theorem which states that, in order to restore the original input signals from the observed signals, sampling needs to be performed at a frequency equal to or greater than double the frequency of the input signals. That is, the setting unit 19 has to set the frequency of the sinusoidal wave function in such a way that the number of pixels in one period of the sinusoidal wave function in the second pattern, which is projected by the projector 13, is captured by the image capturing unit 15 using the pixels equal to or smaller than half in number than the captured number of pixels.

For that, for each projection unit pixel, the setting unit 19 obtains the number T of pixels in one period of the sinusoidal wave function. Firstly, for each projection unit pixel, the setting unit 19 sets, as candidates for the number T of pixels, the natural numbers equal to or smaller than half of the number m(x, y) of pixels calculated at the corresponding image unit pixel. For example, when m(x, y)=12 holds true, the candidates for the number of pixels are six, five, four, three, two, and one.

Then, in descending order of the candidates for the number T of pixels, the setting unit 19 calculates a phase error, which represents the error in the phase value of the sinusoidal wave function at the corresponding candidate for the number T of pixels, using Equation (4) given below. If the phase error is equal to or smaller than a threshold value, then the setting unit 19 sets that candidate for the number T of pixels as the number T of pixels. However, if the phase error is exceeding the threshold value, then the setting unit 19 calculates the phase error at the next candidate for the number T of pixels.

$$Error = {\sum }_{i = 1}^{T} {[ I ( {x}_{i} , {y}_{i} ) - α cos ( φ + 2 π {θ}_{x} x + 2 π {θ}_{y} y ) - β ]}^{2} \qquad ( 4 )$$

Herein, I(xᵢ, yᵢ) represents the luminance value of a pixel (xᵢ, yᵢ); α represents the amplitude of the sinusoidal wave function; β represents an offset component; φ represents the phase; θₓ represents an already-known frequency of the sinusoidal wave function in the x-direction; and θ_{y} represents an already-known frequency of the sinusoidal wave function in the y-direction. Moreover, the frequencies θₓ and θ_{y} are determined according to the number T of pixels.

Lastly, as the frequency of the sinusoidal wave function that is used in generating the second pattern, the setting unit 19 sets the frequencies θₓ and θ_{y} corresponding to the calculated number T of pixels.

The generator 21 generates a second pattern in which the luminance value changes according to the sinusoidal wave function having the frequency set by the setting unit 19. More particularly, the generator 21 generates a second pattern in which the luminance value of each projection unit pixel changes according to the sinusoidal wave function having the frequency set for the projection unit pixel by the setting unit 19. For example, the generator 21 generates a second pattern, in which the luminance value changes, for each projection unit pixel according to Equation (5) given below.

I(x,y)=α(x,y)cos θ(φ(x,y)+2πθₓx+2πθ_{y}y)+β(x,y) (5)

Herein, α(x, y) represents the amplitude of the sinusoidal wave function; β(x, y) represents an offset component; φ(x, y) represents the phase value; I(x, y) represents the luminance value of a pixel (x, y); θₓ represents the frequency of the sinusoidal wave function in the x-direction; and θ_{y} represents the frequency of the sinusoidal wave function in the y-direction. Herein, α(x, y) and β(x, y) are assumed to be arbitrary values set in advance. Moreover, the frequencies θₓ and θ_{y} respectively represent the frequencies θₓ and θ_{y} set at the number T of pixels by the setting unit 19. Moreover, in the first embodiment, the directions of the frequencies θₓ and θ_{y} can be set in an arbitrary manner.

Herein, the explanation about the projector 13 is given again. The projector 13 projects the second pattern, which is generated by the generator 21, onto the object. At that time, the projector 13 stops the projection of the first pattern before projecting the second pattern onto the object.

The explanation about the image capturing unit 15 is given again. The image capturing unit 15 captures a second image of the object onto which the second pattern has been projected.

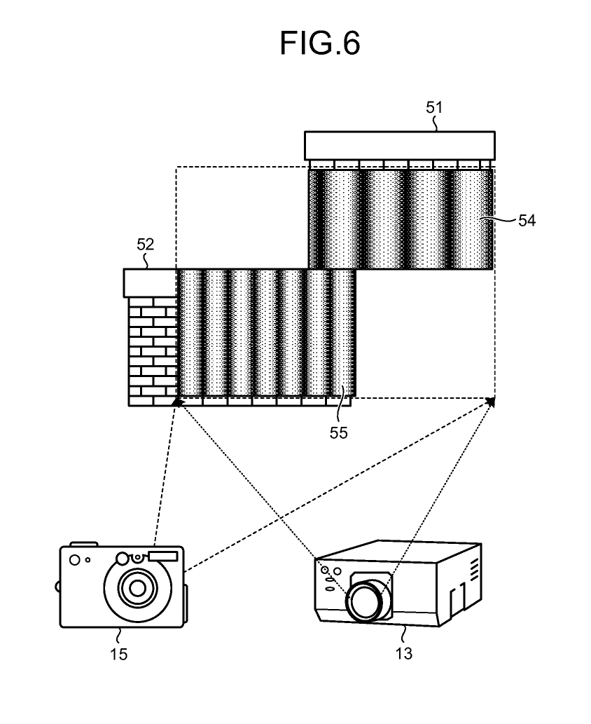

FIG. 6 is a diagram illustrating exemplary second patterns projected onto objects 51 and 52 according to the first embodiment. In the example illustrated in FIG. 6, longer the projection distance of the projector 13, greater is the width of the striped design of the second pattern. Thus, a second pattern 54 that is projected onto the object 51 has the striped design of a greater width as compared to the width of the striped design of a second pattern 55 projected onto the object 52.

In the first embodiment, the frequency of the sinusoidal wave function is set for each projection unit pixel according to the method described earlier. Hence, longer the projection distance, greater is the width of the striped design of the second pattern. Hence, according to the first embodiment, the image capturing unit 15 can capture the second pattern at a suitable resolution for the projection distance.

The second calculator 23 calculates the three-dimensional shape of the object by using the second pattern generated by the generator 21 and the second image captured by the image capturing unit 15. That is, the second calculator 23 calculates the three-dimensional shape of the object according to the phase shift method.

More particularly, the second calculator 23 uses the second pattern generated by the generator 21 and calculates the phase value for each pixel constituting the second image. For example, the phase value for each pixel constituting the second image can be obtained using Equation (6) given below.

$$arg min [ α , β , φ ] = {\sum }_{i = 1}^{n} {[ I ( {x}_{i} , {y}_{i} ) - α cos ( φ + 2 π {θ}_{x} x + 2 π {θ}_{y} y ) - β ]}^{2} \qquad ( 6 )$$

Herein, α represents the amplitude of the sinusoidal wave function; β represents an offset component; φ represents the phase value; and I(xᵢ, yᵢ) represents the luminance value of a pixel (xᵢ, yᵢ) in the vicinity of the pixel of interest (x, y) in the second image. As a result of using Equation (6), from the luminance values I(xᵢ, yᵢ) of n number of points (n≧3), it becomes possible to obtain such α, β, and φ that minimize the residual sum of squares.

Meanwhile, since Equation (6) represents a nonlinear least square problem, it is not possible to calculate a unique solution. For that reason, if ε_{c}=α cos θ and εₛ=α sin θ are set, Equation (6) becomes a linear least square problem given below in Equation (7).

$$arg min [ α , {ɛ}_{c} , {ɛ}_{s} ] = {\sum }_{i = 1}^{n} {[ I ( {x}_{i} , {y}_{i} ) - α - {ɛ}_{c} cos ( 2 π {θ}_{x} x + 2 π {θ}_{y} y ) + {ɛ}_{s} ( 2 π {θ}_{x} x + 2 π {θ}_{y} y ) - β ]}^{2} \qquad ( 7 )$$

Equation (7) can be obtained in an analytical manner using linear equations given below in Equation (8) to Equation (10).

$$\begin{matrix}A ( \begin{matrix}α \\ {ɛ}_{c} \\ {ɛ}_{s}\end{matrix} ) = g , & ( 8 ) \\ A ( \begin{matrix}n & \sum cos ( 2 π {θ}_{x} x + 2 π {θ}_{y} y ) & \sum - sin ( 2 π {θ}_{x} x + 2 π {θ}_{y} y ) \\ \sum cos ( 2 π {θ}_{x} x + 2 π {θ}_{y} y ) & \sum {cos ( 2 π {θ}_{x} x + 2 π {θ}_{y} y )}^{2} & \sum - sin ( 2 π {θ}_{x} x + 2 π {θ}_{y} y ) cos ( 2 π {θ}_{x} x + 2 π {θ}_{y} y ) \\ \sum - sin ( 2 π {θ}_{x} x + 2 π {θ}_{y} y ) & \sum - sin ( 2 π {θ}_{x} x + 2 π {θ}_{y} y ) cos ( 2 π {θ}_{x} x + 2 π {θ}_{y} y ) & \sum {sin ( 2 π {θ}_{x} x + 2 π {θ}_{y} y )}^{2}\end{matrix} ) , & ( 9 ) \\ g = ( \begin{matrix}\sum I ( {x}_{i} , {y}_{i} ) \\ \sum I ( {x}_{i} , {y}_{i} ) cos ( 2 π {θ}_{x} x + 2 π {θ}_{y} y ) \\ \sum - I ( {x}_{i} , {y}_{i} ) sin ( 2 π {θ}_{x} x + 2 π {θ}_{y} y )\end{matrix} ) & ( 10 )\end{matrix}$$

Using ε_{c} and εₛ obtained from Equation (8) to Equation (10), the phase value φ can be obtained according to Equation (11) given below.

$$φ = arc tan ( \frac{{ɛ}_{s}}{{ɛ}_{c}} ) \qquad ( 11 )$$

Then, the second calculator 23 uses the calculated phase value φ and obtains the corresponding position between the second image and the second pattern with sub-pixel accuracy; and calculates the three-dimensional shape of the object by implementing an existing three-dimensional distance measuring method, such as triangulation, with respect to the corresponding position thus obtained. As the method of calculating the three-dimensional shape using the phase value, it is possible to implement the triangulation method mentioned in “Precision improvement method for phase shifting based on projector-camera stereo system using response function (MIRU2009, 2009)”.

The output unit 25 outputs the three-dimensional shape of the object as calculated by the second calculator 23. For example, the output unit 25 can output the three-dimensional shape of the object on the screen of a display unit (not illustrated), or can output the three-dimensional shape of the object to the memory 11, or can output the three-dimensional shape of the object to a printing unit (not illustrated) for printing purposes.

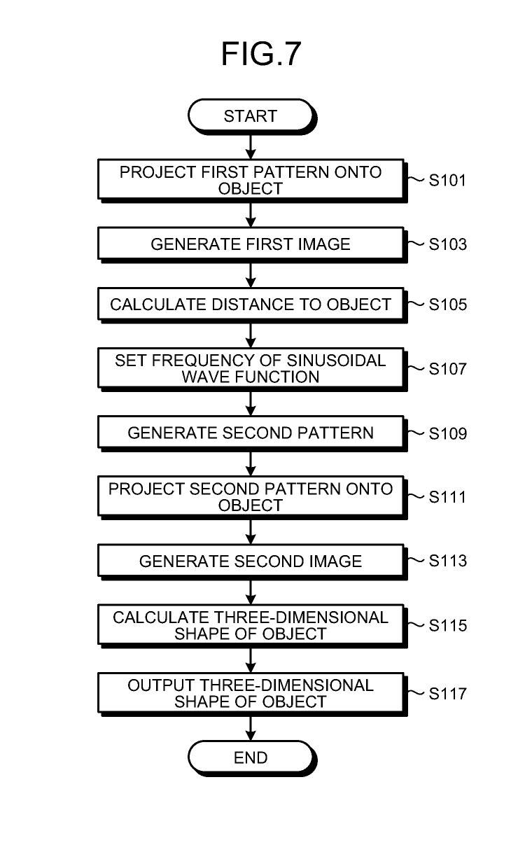

FIG. 7 is a flowchart for explaining an exemplary sequence of operations performed in the measuring device 10 according to the first embodiment.

Firstly, the projector 13 projects the first pattern, which is stored in the memory 11, onto an object (Step S101).

Then, the image capturing unit 15 captures (generates) a first image that is an image of the object onto which the first pattern is projected by the projector 13 (Step S103).

Subsequently, by using the first pattern stored in the memory 11 and the first image captured by the image capturing unit 15, the first calculator 17 calculates the distance to the object for each image unit pixel of the first image (Step S105).

Then, by using the distance that is calculated for each image unit pixel by the first calculator 17, the setting unit 19 sets the frequency of the sinusoidal wave function for each projection unit pixel of the projector 13 (Step S107).

Subsequently, the generator 21 generates a second pattern in which the luminance value of each projection unit pixel changes according to the frequency of the sinusoidal wave function set for that projection unit pixel by the setting unit 19 (Step S109).

Then, the projector 13 projects the second pattern, which is generated by the generator 21, onto the object (Step S111).

Subsequently, the image capturing unit 15 captures (generates) a second image of the object onto which the second pattern is projected (Step S113).

Subsequently, by using the second pattern generated by the generator 21 and the second image captured by the image capturing unit 15, the second calculator 23 calculates the three-dimensional shape of the object (Step S115).

Then, the output unit 25 outputs the three-dimensional shape of the object as calculated by the second calculator 23 (Step S117).

As described above, in the first embodiment, the frequency of the sinusoidal wave function is set for each projection unit pixel. Hence, longer the projection distance, greater is the width of the striped design of the second pattern. Hence, according to the first embodiment, the width of the striped design of the second pattern can be set in such a way that imaging can be done at a suitable resolution for the projection distance without having to use a reference object. Moreover, the three-dimensional shape of the object can be measured with a high degree of accuracy and without having to use a reference object.

Besides, according to the first embodiment, since the frequency of the sinusoidal wave function is set for each projection unit pixel, a suitable frequency of the sinusoidal wave function can be set not only at units of the period of the sinusoidal wave function but also at units of the projection unit pixel. Thus, the three-dimensional shape of the object can be measured with a high degree of accuracy.

### Second Embodiment

In a second embodiment, the explanation is given for an example in which the direction of the sinusoidal wave function (i.e., the direction of the striped design of the second pattern) is set for each projection unit pixel. The following explanation is mainly given about the differences with the first embodiment, and the constituent elements having identical functions to the first embodiment are referred to by the same reference numerals and their explanation is not repeated.

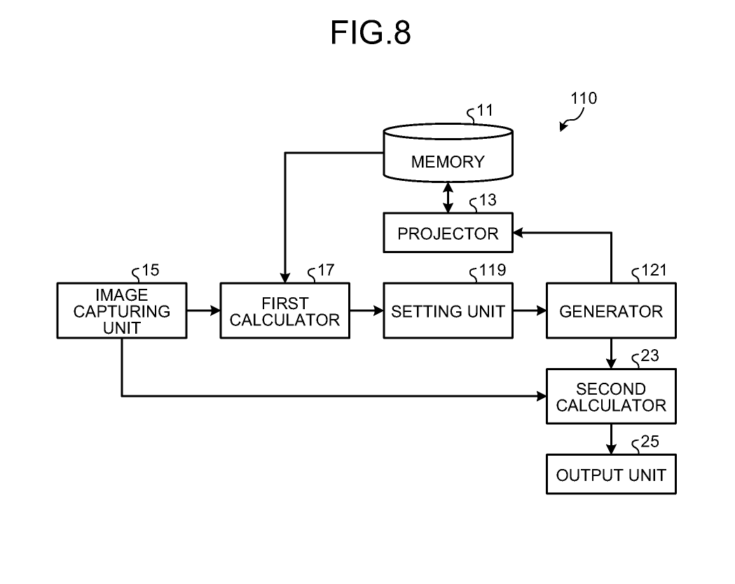

FIG. 8 is a block diagram illustrating an exemplary configuration of a measuring device 110 according to the second embodiment. As illustrated in FIG. 8, in the measuring device 110 according to a second embodiment, a setting unit 119 and a generator 121 are different than the first embodiment.

The setting unit 119 further sets the direction of the sinusoidal wave function by using the distance calculated by the first calculator 17. Herein, the setting unit 119 sets the direction of the sinusoidal wave function for each projection unit pixel of the projector 13. More particularly, for each projection unit pixel, the setting unit 119 calculates a plurality of directions of curvature of the object by using the three-dimensional distance calculated by the first calculator 17; and, from among the calculated directions of curvature, sets a predetermined direction of curvature as the direction of the sinusoidal wave function. Herein, the predetermined direction of curvature is, for example, the direction of smallest curvature from among the directions of curvature.

For example, by using the three-dimensional distance calculated by the first calculator 17, the setting unit 119 calculates the principal directions of curvature and sets the direction of smallest curvature, which corresponds to the principal direction of smallest curvature, as the direction of the sinusoidal wave function.

More particularly, with respect to a group of points within a certain radius around the three-dimensional points obtained with the three-dimensional distance, the setting unit 119 performs local quadratic-surface fitting and calculates the principal direction of smallest curvature.

Herein, the setting unit 119 performs principal component analysis with respect to the three-dimensional coordinates of the group of points; and fits, to the group of points, a quadratic surface function z=ax²+bxy+cy²+dx+ey+f that constitutes a coordinate system in which the unit vectors in the directions of the first to third principle components serve as the basis and that has the height direction along the axis having the smallest dispersion of three-dimensional positions.

Then, from the quadratic surface representing the fitting result, the setting unit 119 calculates the principal direction and the normal direction that respectively represent the direction in which the curvature is the greatest and the direction in which the curvature is the smallest. The setting unit 119 performs such local quadratic-surface fitting with respect to all three-dimensional points obtained with the three-dimensional distance, and obtains the direction of smallest curvature for all three-dimensional points.

Herein, in each localized area, the direction of smallest curvature is identical in an ideal scenario. However, in practice, due to the effect of estimation errors, the principal direction of smallest curvature does not remain constant in one direction. In that regard, in the second embodiment, the setting unit 119 eliminates the outlier by means of polling; averages the principal directions; determines a principal direction V(x, y) of smallest curvature; and sets the principal direction V(x, y) of smallest curvature as the direction of the sinusoidal wave function.

The generator 121 generates a second pattern in which the luminance value changes according to the sinusoidal wave function having the frequency and the direction set by the setting unit 119. More particularly, the generator 121 generates a second pattern in which the luminance value of each projection unit pixel changes according to the sinusoidal wave function having the frequency and the direction set for the projection unit pixel by the setting unit 119. For example, the generator 121 generates a second pattern, in which the luminance value changes, for each projection unit pixel according to Equation (12) given below.

I(x,y)=α(x,y)cos θ(φ(x,y)+2πθᵥₓx+2πθ_{vy}y)+β(x,y) (12)

Herein, α(x, y) represents the amplitude of the sinusoidal wave function; β(x, y) represents an offset component; φ(x, y) represents the phase value; I(x, y) represents the luminance value of the pixel (x, y); θᵥₓ represents the frequency of the sinusoidal wave function in the x-direction of the principal direction of smallest curvature; and θ_{vy} represents the frequency of the sinusoidal wave function in the y-direction of the principal direction of smallest curvature.

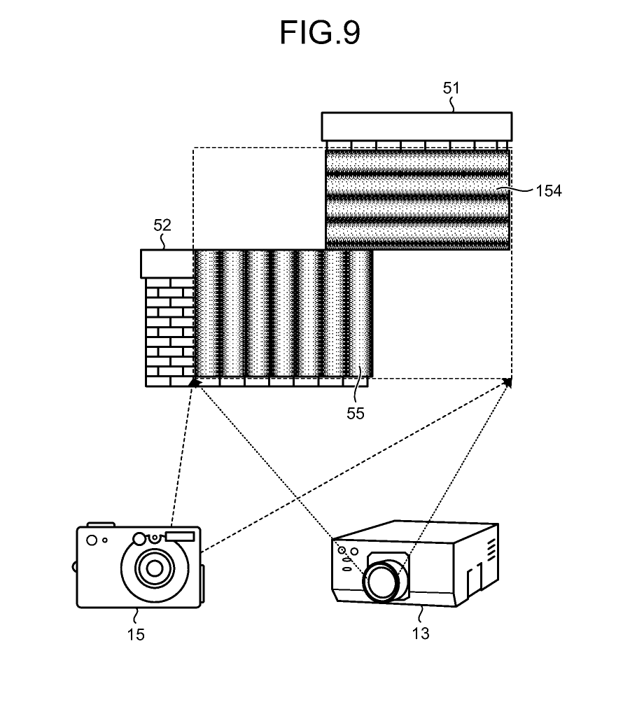

FIG. 9 is a diagram illustrating exemplary second patterns projected onto the objects 51 and 52 according to the second embodiment. In the example illustrated in FIG. 9, longer the projection distance of the projector 13, greater is the width of the striped design of the second pattern. Moreover, the direction of smallest curvature is set as the direction of the sinusoidal wave pattern. Consequently, a second pattern 154 that is projected onto the object 51 has the striped design of a greater width as compared to the width of the striped design of the second pattern 55 projected onto the object 52. Besides, the direction of the striped design of the second pattern 55 is different form the direction of the striped design of the second pattern 154.

In the second embodiment, the frequency and the direction of the sinusoidal wave function are set for each projection unit pixel in the manner described above. Therefore, the striped design is not stretched in the direction in which the curvature is greater, thereby making it possible to measure the three-dimensional shape of the object with a higher degree of accuracy.

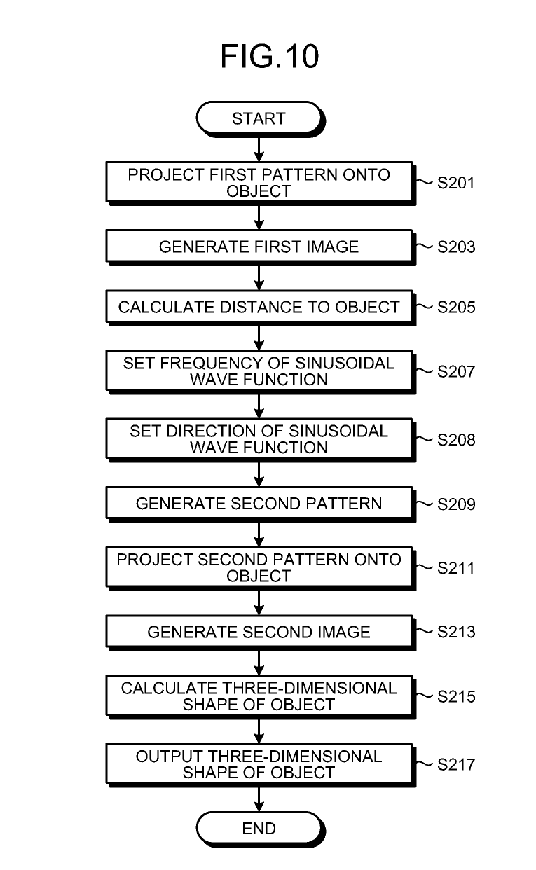

FIG. 10 is a flowchart for explaining an exemplary sequence of operations performed in the measuring device 110 according to the second embodiment.

Firstly, the operations performed at Steps S201 to S207 are identical to the operations performed at Steps S101 to S107 in the flowchart illustrated in FIG. 7.

Then, by using the distance of each image unit pixel as calculated by the first calculator 17, the setting unit 119 sets the direction of the sinusoidal wave function for each projection unit pixel of the projector 13 (Step S208).

Subsequently, the generator 121 generates a second pattern in which the luminance value of each projection unit pixel changes according to the frequency and the direction of the sinusoidal wave function set for that projection unit pixel by the setting unit 119 (Step S209).

Then, the operations performed at Steps S211 to S217 are identical to the operations performed at Steps S111 to S117 in the flowchart illustrated in FIG. 7.

As described above, according to the second embodiment, the frequency and the direction of the sinusoidal wave function are set for each projection unit pixel in the manner described above. Therefore, the striped design is not stretched in the direction in which the curvature is greater, thereby making it possible to measure the three-dimensional shape of the object with a higher degree of accuracy.

Hardware Configuration

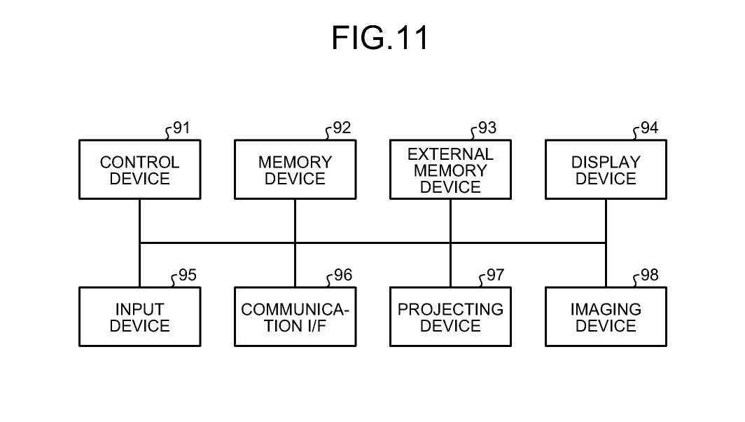

FIG. 11 is a block diagram illustrating an exemplary hardware configuration of the measuring device according to the embodiments described above. As illustrated in FIG. 11, the measuring device according to the embodiments described above has the hardware configuration of a commonly-used computer that includes a control device 91 such as a central processing unit (CPU); a memory device 92 such as a read only memory (ROM) or a random access memory (RAM); an external memory device 93 such as a hard disk drive (HDD) or a solid state drive (SSD); a display device 94 such as a display; an input device 95 such as a mouse or a keyboard; a communication I/F 96; a projecting device 97 such as a projector; and an imaging device 98 such as a digital camera.

The computer programs that are executed in the measuring device according to the embodiments described above are stored in advance in a ROM.

Alternatively, the computer programs that are executed in the measuring device according to the embodiments described above can be recorded in the form of installable or executable files in a computer-readable recording medium such as a compact disk read only memory (CD-ROM), a compact disk readable (CD-R), a memory card, a digital versatile disk (DVD), or a flexible disk (FD).

Still alternatively, the computer programs that are executed in the measuring device according to the embodiments described above can be saved as downloadable files on a computer connected to the Internet or can be made available for distribution through a network such as the Internet.

Meanwhile, the computer programs that are executed in the measuring device according to the embodiments described above contain a module for each of the abovementioned constituent elements to be implemented in a computer. As the actual hardware, for example, the control device 91 reads the computer programs from the external memory device 93 and runs them such that the computer programs are loaded in the memory device 92. As a result, the module for each of the abovementioned constituent elements is implemented in the computer.

As explained above, according to the embodiments described above, the three-dimensional shape of an object can be measured with a high degree of accuracy and without having to use a reference object.

Unless contrary to the nature thereof, the steps of the flowcharts according to the embodiments described above can have a different execution sequence, can be executed in plurality at the same time, or can be executed in a different sequence every time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measuring device comprising:
a projector to project, onto an object, a first pattern in which predetermined designs are distributed randomly and a second pattern in which a luminance value changes according to a sinusoidal wave function having a frequency;
an image capturing unit to capture a first image of the object onto which the first pattern is projected and a second image of the object onto which the second pattern is projected;
a first calculator to calculate a distance to the object by using the first pattern and the first image;
a setting unit to set the frequency of a sinusoidal wave function by using the distance; and
a second calculator to calculate a three-dimensional shape of the object by using the second pattern and the second image.

2. The device according to claim 1, further comprising a generator to generate the second pattern, wherein
the setting unit sets a frequency of the sinusoidal wave function for each projection unit pixel that represents a unit pixel of the projector, and
the generator generates, for each of the projection unit pixels, the second pattern in which a luminance value changes according to the sinusoidal wave function having the frequency set for the projection unit pixel.

3. The device according to claim 2, wherein
for each image unit pixel that represents a unit pixel of the first image, the first calculator calculates, as the distance, three-dimensional distance from the measuring device to a position of the object corresponding to the image unit pixel,
the setting unit calculates, for each of the image unit pixels, a number of pixels of projection unit pixels corresponding to the image unit pixel by using the three-dimensional distance to the image unit pixel, and sets the frequency at each of the projection unit pixels based on the number of pixels calculated for a corresponding image unit pixel.

4. The device according to claim 3, wherein, for each of the projection unit pixels, the setting unit performs setting in such a way that a number of pixels required for a unit period of the sinusoidal wave function at the projection unit pixel is equal to or smaller than half of the number of pixels calculated at the image unit pixel corresponding to the projection unit pixel, and sets the frequency at the projection unit pixel according to the number of pixels thus set.

5. The device according to claim 4, wherein, the setting unit sets, as a number of pixels required for a unit period of the sinusoidal wave function at the projection unit pixel, natural numbers in descending order that are equal to or smaller than half of the number of pixels calculated at the image unit pixel corresponding to the projection unit pixel to calculate phase errors of the sinusoidal wave function, and sets a natural number having the phase error equal to or greater than a threshold value as the number of pixels required for the unit period.

6. The device according to claim 1, wherein
the setting unit further sets a direction of the sinusoidal wave function by using the distance, and
the generator generates the second pattern in which a luminance value changes according to the sinusoidal wave function having the frequency and the direction.

7. The device according to claim 6, wherein
the setting unit sets a direction of the sinusoidal wave function for each of the projection unit pixels, and
the generator generates, for each of the projection unit pixels, the second pattern in which a luminance value changes according to the sinusoidal wave function having the frequency and the direction set for the projection unit pixel.

8. The device according to claim 7, wherein, for each of the projection unit pixels, the setting unit calculates a plurality of directions of curvature of the object by using the distance and, from among the plurality of directions of curvature thus calculated, sets a predetermined direction of curvature as the direction of the sinusoidal wave function.

9. The device according to claim 8, wherein the predetermined direction of curvature is direction of the smallest curvature from among the plurality of directions of curvature.

10. The device according to claim 2, wherein the projection unit pixel represents a single pixel.

11. The device according to claim 3, wherein the image unit pixel represents a single pixel.

12. The device according to claim 4, wherein the unit period represents a single period.

13. A measuring method comprising:
projecting, onto an object, a first pattern in which predetermined designs are distributed randomly and a second pattern in which a luminance value changes according to a sinusoidal wave function having a frequency;
capturing a first image of the object onto which the first pattern is projected and a second image of the object onto which the second pattern is projected;
calculating a distance to the object by using the first pattern and the first image;
setting the frequency of a sinusoidal wave function by using the distance; and
calculating a three-dimensional shape of the object by using the second pattern and the second image.

14. A computer program product comprising a computer readable medium including programmed instructions, wherein the instructions, when executed by a computer, cause the computer to perform:
projecting, onto an object, a first pattern in which predetermined designs are distributed randomly and a second pattern in which a luminance value changes according to a sinusoidal wave function having a frequency;
capturing a first image of the object onto which the first pattern is projected and a second image of the object onto which the second pattern is projected;
calculating a distance to the object by using the first pattern and the first image;
setting the frequency of a sinusoidal wave function by using the distance; and
calculating a three-dimensional shape of the object by using the second pattern and the second image.
